(19) United States
(12) Patent Application Publication
(10) Pub. No.: US 2006/0218739 A1
(43) Pub. Date: Oct. 5, 2006

(54) Wheel for removing adhesive tape and adhesive

(76) Inventor: Pai-Lung Hsu, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/091,516

(22) Filed: Mar. 29, 2005

(51) Int. Cl. B08B 1/04

(52) U.S. Cl. 15/230.16; 15/230

(57) ABSTRACT

A wheel has several equidistantly spaced apart gaps on each of the annular edges of two sides thereof, and a tooth-shaped portion between every two adjacent ones of the gaps; when the wheel is turned while being pressed against an object, which has adhesive on the surface, the adhesive will be removed; because the gaps are formed, when the wheel is used to remove adhesive from the surface of an object, the area of contact between the wheel and the object won't be too large, and in turn damage of the surface of the object is prevented, and the wheel will wear down more slowly.

### BACKGROUND OF THE INVENTION

1. Field of the Invention

The present invention relates to a wheel for removing adhesive tapes and adhesive, more particularly one, which is connected to an air-actuated tool such that it will be turned together with a turning unit of the air-actuated tool to remove adhesive from an object when the tool is actuated.

2. Brief Description of the Prior Art

Decorative stickers are available for cars and other articles. Such decorative stickers are used to make cars look more attractive, and they are stuck on cars by means of adhesive tapes or adhesive. If the stickers fade, the user wants to change stickers or the user wants to repaint his car, first the original stickers have to be removed, and the adhesive tapes and adhesive have to be got rid of by means of a rubber wheel, which is pressed against the surface of the car, and turned with a turning unit of an air-actuated tool.

For example, U.S. Pat. No. 5,259,914 teaches a glue removing wheel. The glue removing wheel is made of rubber, and has an annular side for touching the surface of a car, which has adhesive tapes and adhesive thereon to be removed. However, because the annular side has an continuous surface, it is prone to damage the surface of the car and wear down very soon.

### SUMMARY OF THE INVENTION

It is a main object of the invention to provide an improvement on an adhesive removing wheel to overcome the above-mentioned problem.

The wheel of the present invention has several equidistantly spaced apart gaps on each of the annular edges of two sides thereof, and a tooth-shaped portion between every two adjacent ones of the gaps. Because the wheel has the gaps, when the wheel is used to remove adhesive from the surface of an object, the area of contact between the wheel and the object will be smaller, and in turn damage of the surface of the object is prevented, and the wheel will wear down more slowly.

### BRIEF DESCRIPTION OF THE DRAWINGS

The present invention will be better understood by referring to the accompanying drawings, wherein:

FIG. 1 is a perspective view of the wheel for removing adhesive tape and adhesive according to the present invention,

FIG. 2 is a side view of the wheel of the invention, and

FIG. 3 is a side view of the wheel of the invention connected to an air-actuated tool.

### DETAILED DESCRIPTION OF THE PREFERRED EMBODIMENTS

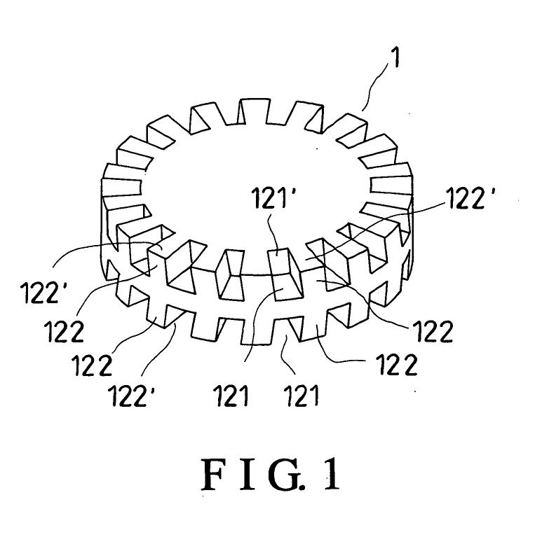

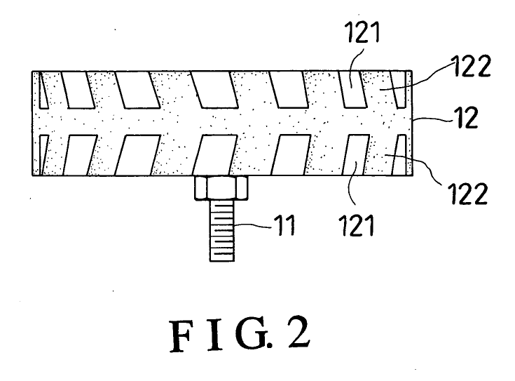

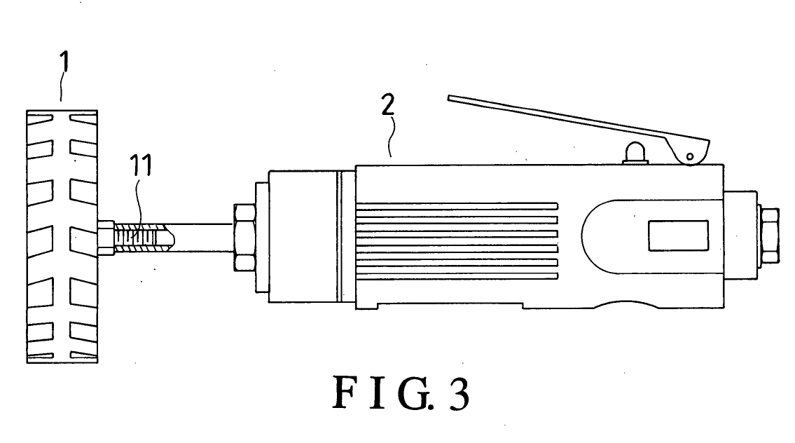

Referring to FIGS. 1 and 2, a preferred embodiment 1 of a wheel for removing adhesive tapes and adhesive is made of rubber, and made into single part. The adhesive removing wheel 1 has a connecting shaft 11, which is secured on a center of a first one of two sides of the wheel 1 for connection to a turning unit of an air-actuated tool 2, as shown in FIG. 3. And, the wheel 1 has several equidistantly spaced apart gaps on each of the annular edges of the two sides thereof, and a tooth-shaped portion between every two adjacent ones of the gaps, which gaps have the same dimensions; each of the gaps has a first opening 121 facing a radial direction of the wheel 1, and a second opening 121′ facing in the axial direction of the wheel 1; each of the tooth-shaped portions has a first side 122 substantially facing in a radial direction of the wheel 1, and a second side 122′ substantially facing in the axial direction of the wheel 1. Furthermore, the gaps are formed in such a way that the tooth-shaped portions slope, each having an obtuse angle and an acute angle at the outward end as shown in FIG. 2; in other words, the other two sides of each of the tooth-shaped portions aren't parallel to the connecting shaft 11 as shown in FIG. 3.

Thus, the user will remove adhesive tapes and adhesive from the surface of an object if he actuates the air-actuated tool 2 to make the adhesive removing wheel 1 start turning with the turning unit of the air-actuated tool 2 while making the adhesive removing wheel 1 touch the adhesive tapes and the adhesive closely at the edge thereof; the wheel 1 will rub the adhesive tapes and the adhesive at the first sides of the tooth-shaped portions thereof. In addition, the wheel 1 has to be turned in a direction the same as the sloping direction of the sloping sides of the tooth-shaped portions of the wheel 1; in other words, the wheel 1 has to be turned in such a direction that the obtuse angle of each tooth-shaped portion is ahead of the corresponding acute angle; for instance, the wheel 1 shown in FIG. 2 should be turned in a counterclockwise direction.

When comparing the adhesive removing wheel of the present invention with the conventional one, we can see the following facts:

First, because the present invention has the gaps between every two adjacent ones of the tooth-shaped portions, the area of contact between the present invention and the object will be smaller than that between the conventional wheel and the object, and in turn frictional resistance of the object against the present invention is reduced, and damage of the surface of the object is prevented, and the present wheel will wear down more slowly.

Secondly, the adhesive removing wheel of the present invention can remove adhesive tapes and adhesive more thoroughly because of the tooth-shaped portions.

What is claimed is:

1. An improvement on a wheel for removing adhesive tape and adhesive, having
a connecting shaft secured on a center of a first one of two sides thereof for connection to a turning unit of an air-actuated tool;
a plurality of gaps on an annular edge thereof; and
a tooth-shaped portion between every two adjacent ones of the gaps thereof.

2. The wheel as claimed in claim 1, wherein the gaps are formed on annular edges of the two sides of the wheel.

3. The wheel as claimed in claim 2, wherein the gaps have same dimensions, and are equidistantly spaced apart.

4. The wheel as claimed in claim 3, wherein the gaps are in sloping position.

5. The wheel as claimed in claim 4, wherein the wheel is used by means of turning the wheel in a direction same as a sloping direction of the gaps of the wheel.

6. The wheel as claimed in claim 2, wherein each of the gaps has a first opening facing a radial direction of the wheel, and a second opening facing in an axial direction of the wheel while each of the tooth-shaped portions has a first side substantially facing in a radial direction of the wheel, and a second side substantially facing in an axial direction of the wheel.
